(19) United States
(12) Patent Application Publication
(10) Pub. No.: US 2026/0175182 A1
(43) Pub. Date: Jun. 25, 2026

(54) Transfer System for Electrode Raw Materials

(71) Applicant: LG Energy Solution, Ltd., Seoul (KR)

(72) Inventors: Woong Ju Bang, Daejeon (KR); Jae Huoung Son, Daejeon (KR); Sung Jong Shin, Daejeon (KR)

(73) Assignee: LG Energy Solution, Ltd., Seoul (KR)

(21) Appl. No.: 19/129,199

(22) PCT Filed: May 28, 2024
(86) PCT No.: PCT/KR2024/007207

§ 371 Date: May 12, 2025

(30) Foreign Application Priority Data
Jun. 2, 2023 (KR) 10-2023-0071697

(51) Int. Cl. B01F 27/072

(52) U.S. Cl. CPC B01F 27/0726

(57) ABSTRACT

An electrode raw material transfer system including a stirring part having an inlet portion into which electrode raw materials are introduced, and for mixing the electrode raw materials, a sensor part for measuring a pressure within the stirring part, an air injection part provided at the inlet portion of the stirring part for spraying air into the inlet portion, a vibration part for applying vibration to the inlet portion, and a control part for adjusting an air injection pressure of the air injection part, based on the pressure within the stirring part is provided.

### CROSS-REFERENCE TO RELATED APPLICATIONS

This application is a 371 National Stage entry of PCT/KR 2024/007207, filed May 28, 2024, which claims the benefit of foreign priority based on Korean Patent Application No. 10-2023-0071697 dated Jun. 2, 2023, the disclosures of which are incorporated by reference herein in their entirety.

### TECHNICAL FIELD

The present disclosure relates to a transfer system for electrode raw materials, and relates, particularly, to a transfer system for powder-type electrode raw materials, which relates, specifically, to a transfer system for electrode raw materials capable of preventing clogging of an inlet portion in a stirring part due to the electrode raw materials by applying pneumatic pressure and vibration to the inlet portion.

### BACKGROUND

A secondary battery is a battery capable of recharging, which is configured to repeat charging and discharging by moving ions in an electrolyte between a positive electrode and a negative electrode insulated by a separator. The secondary battery may comprise an electrode assembly, and a case embedding the electrode assembly, where the electrode assembly is formed by alternately laminating positive electrodes, negative electrodes, and separators.

A process for manufacturing a secondary battery comprises an electrode process, an assembly process, and an activation process. Here, the electrode process is a process for manufacturing a positive electrode and a negative electrode. The positive electrode or negative electrode is manufactured through the following processes sequentially.

The electrode process comprises a mixing process, a coating process, a rolling process, a slitting process, and a notching process.

FIG. 1 schematically shows a conventional mixing device, and FIG. 2 is a schematic cross-sectional diagram cut along Line A-A in FIG. 1.

The mixing process is a process of measuring and mixing various electrode raw materials, where in the mixing process, various electrode raw materials are mixed to form a liquid slurry.

The slurry is a mixture of an active material, a conductive material, a binder, and a solvent. The active material and the conductive material are dry-mixed in the form of powder. Thereafter, the active material and the conductive material are wet-mixed in the solvent in which the binder is dissolved, thereby forming the slurry.

The mixing device (10) comprises a raw material supply hopper (20) into which the powder-type electrode raw material (50) is introduced, and a stirring part (30) where the electrode raw material (50) supplied from the hopper (20) is stirred.

As the powder-type electrode raw material (50), various active materials may be used depending on the type of secondary battery product. In particular, the used amounts of positive electrode active material and negative electrode active material are very large, whereby the materials are mainly supplied to the mixing device (10) in the form of powder.

The respective electrode raw materials (50) introduced into the stirring part (30) have different transfer times introduced into the stirring part (30), different mixing times for which the raw materials are mixed in the mixing device (10), and the like, depending on the characteristics of each raw material.

Furthermore, in the process of being transferred from the raw material supply hopper (20) to the stirring part (30), there is a phenomenon that the inlet portion (31) of the stirring part (30) and/or a piping part (40) connecting the raw material hopper (20) and the inlet portion (31) of the stirring part (30) becomes clogged due to an agglomeration phenomenon between the electrode raw materials (50) depending on the characteristics of the electrode raw materials (50). Meanwhile, the inlet portion (31) of the stirring part (30) and the piping part (40) may be connected through a clamp (60).

Here, the agglomeration phenomenon between the electrode raw materials (50) in the form of powder may be caused due to the characteristics of the electrode raw materials (50), and as one aspect, the powder agglomeration phenomenon may be caused by a chemical reaction between the internal moisture component of the mixing device (10) and the electrode raw materials (50) in the form of powder.

If the inlet portion (31) of the stirring part (30) and/or the piping part (40) becomes clogged, the transfer time for the electrode raw material (50) to be transferred to the stirring part (30) takes a long time. In addition, if the inlet portion (31) of the stirring part (30) becomes clogged and thus the input area of the inlet portion (31) is narrowed, it is difficult to accurately calculate the input area through which the electrode raw material (50) passes through the inlet portion (31) per unit time.

Accordingly, there may be a problem in which the electrode raw material (50) is not introduced quantitatively, and when the inlet portion (31) of the stirring part (30) is clogged, there is a problem that a defective slurry is produced due to a metering error in the electrode raw material (50).

Conventionally, when the piping part (40) and/or the inlet portion (31) of the stirring part (30) was clogged upon the mixing process, a worker performed a work of separating the clamp (60) and the piping part (40), and pulverizing the electrode raw material (50) (e.g., positive electrode active material, negative electrode active material, etc.) lumped into lumps at the piping part (40) and/or the inlet portion (31) of the stirring part (30) manually. Accordingly, there was a problem that the mixing process was not performed during the working time, thereby resulting in a decrease in slurry productivity.

### SUMMARY

### Technical Problem

The present disclosure is intended to provide a transfer system for electrode raw materials capable of preventing clogging of an inlet portion in a stirring part due to the electrode raw materials during a mixing process by applying pneumatic pressure and vibration to the inlet portion.

In addition, the present disclosure is intended to provide a transfer system for electrode raw materials capable of shortening a transfer time of the electrode raw materials by preventing clogging of an inlet portion of a stirring part.

### Technical Solution

To solve the above-described problems, the transfer system for electrode raw materials related to one aspect of the present disclosure comprises a stirring part having an inlet portion into which electrode raw materials are introduced, and provided to perform a mixing process for the electrode raw materials, a sensor part provided to measure a pressure within the stirring part, an air injection part provided at the inlet portion of the stirring part and provided to spray air into the inlet portion, a vibration part provided to apply vibration to the inlet portion, and a control part provided to adjust an air injection pressure of the air injection part, based on the pressure within the stirring part. As one aspect, the electrode raw material may be a powder-type electrode raw material.

The air injection part may comprise a plurality of air nozzles disposed within the inlet portion to spray air along the input direction of the electrode raw material, a pneumatic pressure supply part providing pneumatic pressure to each air nozzle, and a regulator for controlling the pneumatic pressure supplied to each air nozzle. As one aspect, the pneumatic pressure supply part may comprise an air pump, and the regulator may adjust the pressure (pneumatic pressure) of the air sprayed from the air nozzle by adjusting a flow rate of air.

Also, the plurality of air nozzles may be arranged apart from each other along the circumferential direction of the inlet portion of the stirring part.

In additionally, the vibration part may comprise an air turbine vibrator.

Furthermore, the control part may be provided to operate the air injection part and the vibration part upon an input mode in which the electrode raw material is introduced into the stirring part.

Also, the control part may operate the air injection part so that the air is sprayed at a first operating pressure lower than the internal pressure of the stirring part upon the input mode.

In addition, upon the input mode, the first operating pressure may be 0.1 MPa to 0.6 MPa.

Furthermore, the control part may control operation of the vibration part so that the vibration is applied at an intensity of 1 kgf to 60 kgf upon the input mode.

Also, the electrode raw material transfer system may comprise a raw material supply part having an outlet portion for supplying the electrode raw material to the stirring part, and a piping part connecting the outlet portion and the inlet portion and guiding transfer of the electrode raw material from the raw material supply part to the stirring part.

In addition, the piping part may comprise a first pipe connected to the stirring part, a second pipe connected to the raw material supply part, and a vibration reduction tube provided in the second pipe.

Furthermore, the first pipe and the second pipe may be connected through a clamp. The first pipe may form the inlet portion of the stirring part, and the second pipe may form the outlet portion of the raw material supply part.

Also, the air injection part and the vibration part may each be provided in the first pipe. As one aspect, the air injection part may be provided to spray air inside the first pipe, and the vibration part may be provided to apply vibration to the first pipe.

In addition, the electrode raw material transfer system may comprise an air knocker mounted on the second pipe and provided to hit the second pipe upon an input mode of the electrode raw material.

Furthermore, the control part may be provided to operate the air injection part and the vibration part continuously and to operate the air knocker at predetermined time intervals, upon the input mode.

Also, the vibration reduction tube may be formed of a silicone material. In addition, the vibration reduction tube may be provided to surround a partial region of the second pipe.

In addition, the electrode raw material transfer system may comprise a vent pipe connected to the stirring part. The control part may be provided to open the vent pipe to the outside upon the input mode. Upon the input mode, as the pneumatic pressure sprayed from the air injection part is applied to the inside of the stirring part, the pressure inside the stirring part may increase. In this instance, by opening the vent pipe to the outside, it is possible to maintain the pressure within the stirring part constant. An electronic valve may be provided in the vent pipe.

Furthermore, the control part may operate the air injection part so that the air is sprayed at a second operating pressure greater than the first operating pressure when the pressure within the stirring part decreases upon the input mode.

### Advantageous Effects

As discussed above, the electrode raw material transfer system related to one aspect of the present disclosure has the following effects.

By applying pneumatic pressure and vibration to the inlet portion of the stirring part, it is possible to prevent clogging of the inlet portion due to electrode raw materials during the mixing process. Particularly, upon an input mode of the electrode raw materials, by spraying the air into the inlet portion of the stirring part, it is possible to prevent the agglomeration phenomenon between the electrode raw materials in the form of powder.

Also, the air sprayed from the air nozzle is sprayed in the input direction of the electrode raw material, whereby the powder-type electrode raw material can be pushed in the input direction and simultaneously introduced into the stirring part in the form of powder.

In addition, by applying vibration to the inlet portion of the stirring part upon an input mode of the electrode raw material, it is possible to prevent the electrode raw material from adhering to the inner surface of the inlet portion.

Furthermore, by preventing clogging of the inlet portion of the stirring part due to electrode raw materials, it is possible to shorten the transfer time of electrode raw materials, and it is possible to improve productivity of the slurry.

In addition, it is possible to minimize an input area error due to clogging of the electrode raw material, and it is possible to minimize a measurement error of the electrode raw material.

### BRIEF DESCRIPTION OF THE DRAWINGS

FIG. 1 schematically shows a conventional mixing device.

FIG. 2 is a schematic cross-sectional diagram cut along Line A-A in FIG. 1.

FIG. 3 is a configuration diagram of a transfer system for electrode raw materials according to one aspect of the present disclosure.

FIG. 4 is a schematic diagram of a transfer system for electrode raw materials according to one aspect of the present disclosure.

FIG. 5 is a schematic cross-sectional diagram cut along Line B-B in FIG. 4.

FIG. 6 is a diagram for explaining one operating state of a transfer system for electrode raw materials according to one aspect of the present disclosure.

FIG. 7 is an enlarged diagram of the inlet portion shown in FIG. 6.

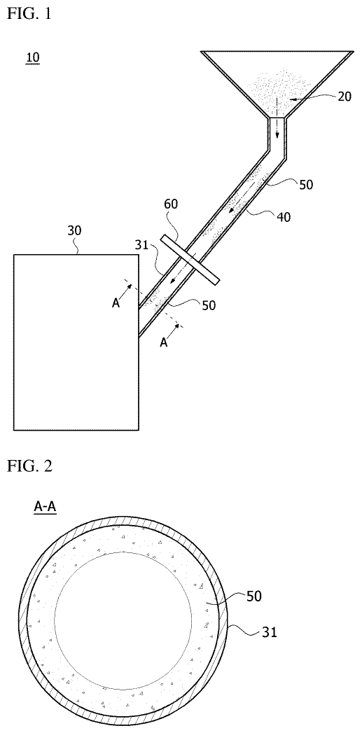

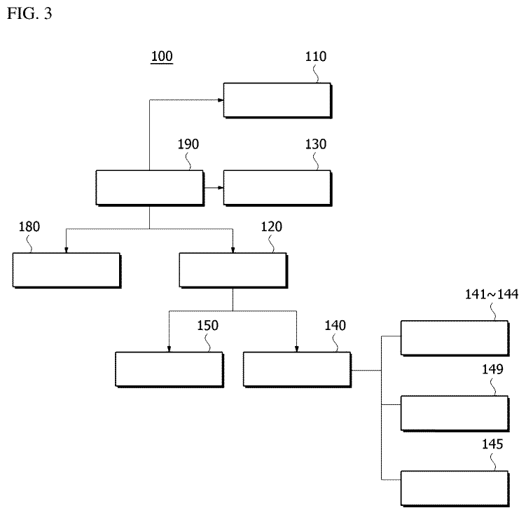

### DETAILED DESCRIPTION

Hereinafter, a transfer system for electrode raw materials according to one aspect of the present disclosure will be described with reference to the accompanying drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

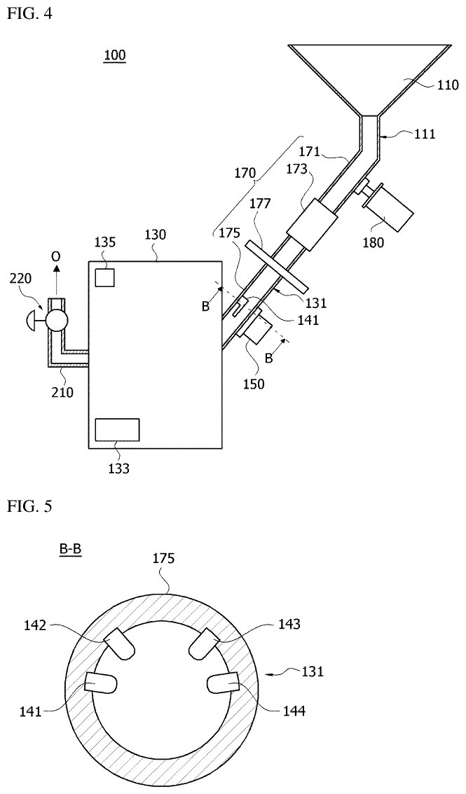

FIG. 3 is a configuration diagram of a transfer system (100) for electrode raw materials according to one aspect of the present disclosure, FIG. 4 is a schematic diagram of a transfer system (100) for electrode raw materials according to one aspect of the present disclosure, and FIG. 5 is a schematic cross-sectional diagram cut along Line B-B in FIG. 4.

As one aspect, in this document, the electrode raw material may be a powder-type electrode raw material.

The electrode raw material transfer system (100) related to one aspect of the present disclosure comprises a stirring part (130) having an inlet portion (131) into which the powder-type electrode raw material (50) is introduced, and provided to perform a mixing process for the electrode raw material (50).

In addition, the electrode raw material transfer system (100) may comprise an occlusion prevention part (120) provided at the inlet portion (131) and provided to provide pneumatic pressure and vibration to the inlet portion (131).

The occlusion prevention part (120) comprises an air injection part (140) and a vibration part (150).

The electrode raw material transfer system (100) comprises a sensor part (135) provided to measure the pressure within the stirring part (130).

The stirring part (130) comprises a stirring unit (133) including a rotating shaft connected to a drive part such as a motor and a plurality of blades mounted on the rotating shaft. The stirring part (130) is provided so that the stirring unit (133) is operated upon an input mode in which electrode raw materials are introduced. When the stirring unit (133) operates, it mixes the electrode raw materials (50) in the stirring part (130) while the rotating shaft is rotated by the drive part and the plurality of blades mounted on the rotating shaft rotates.

Also, the transfer system (100) for the electrode raw materials may comprise an air injection part (140) provided at the inlet portion (131) of the stirring part (130) and provided to spray air into the inlet portion (131).

In addition, the electrode raw material transfer system (100) may comprise a vibration part (150) provided to apply vibration to the inlet portion (131).

Furthermore, the electrode raw material transfer system (100) comprises a control part (190) provided to adjust the air injection pressure of the air injection part based on the pressure within the stirring part (130).

The sensor part (135) may comprise one or more pressure sensors, which is provided to measure the pressure within the stirring part (130). In addition, the measured pressure within the stirring part (130) is transmitted to the control part (190), and the control part (190) is provided to adjust an injection pressure of the air sprayed through the air injection part (140) based on the measured pressure within the stirring part (130).

The air injection part (140) is provided to enable fluid movement with the inside of the inlet portion (131). The air injection part (140) is provided to spray air at a predetermined pneumatic pressure from the inside of the inlet portion (131). In this document, the pressure (pneumatic pressure) of air sprayed through the air injection part (140) may be referred to as operating pressure or injection pressure.

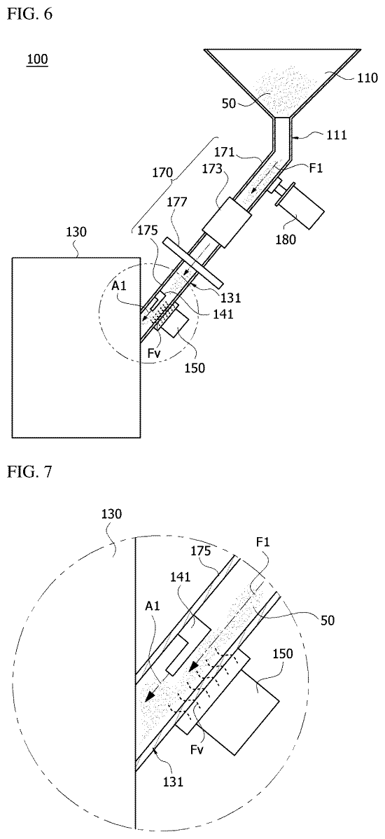

FIG. 6 is a diagram for explaining one operating state of a transfer system (100) for electrode raw materials according to one aspect of the present disclosure, and FIG. 7 is an enlarged diagram of the inlet portion (131) shown in FIG. 6.

The air injection part (140) may comprise a plurality of air nozzles (141 to 144) disposed within the inlet portion (131) to spray air along the input direction (F1) of the electrode raw material (50).

In addition, the air injection part (140) may comprise a pneumatic pressure supply part (149) connected to each air nozzle (141 to 144) and providing pneumatic pressure to each air nozzle (141 to 144), and a regulator (145) for adjusting the pneumatic pressure supplied to each air nozzle (141 to 144). As one aspect, the pneumatic pressure supply part (149) may comprise an air pump, and the regulator (145) may adjust the pressure (pneumatic pressure) of the air sprayed from the air nozzles (141 to 144) by adjusting the flow rate of air.

Each air nozzle (141 to 144) may be provided in the inlet portion (131) to be spaced apart from the vibration part (150). Also, the plurality of air nozzles (141 to 144) may be arranged apart from each other along the circumferential direction of the inlet portion (131) of the stirring part (130).

Referring to FIGS. 6 and 7, the plurality of air nozzles (141 to 144) may be provided in the inlet portion (131) such that the air injection direction (A1) is parallel to the electrode raw material input direction (F1).

The pneumatic pressure supply part (149) is connected to each air nozzle (141 to 144), and the pneumatic pressure supply part (149) provides pneumatic pressure to each air nozzle (141 to 144) upon the input mode of the electrode raw material (50).

Also, the electrode raw material transfer system (100) may comprise a raw material supply part (110) having an outlet portion (111) for supplying the electrode raw material (50) to the stirring part (130), and the raw material supply part (110) may comprise a hopper. In addition, the raw material supply part (110) may also store a powder-type electrode raw material (50), and the electrode raw material (50) may be a positive electrode active material, a negative electrode active material, or a conductive material.

In addition, the transfer system (100) for electrode raw materials may comprise a piping part (170) connecting the outlet portion (111) and the inlet portion (131), and guiding transfer of the electrode raw material (50) from the raw material supply part (110) to the stirring part (130).

Furthermore, the piping part (170) may comprise a first pipe (175) connected to the stirring part (130), a second pipe (171) connected to the raw material supply part (110), and a vibration reduction tube (173) provided in the second pipe (171). In addition, the first pipe (175) and the second pipe (171) may be connected through a clamp (177).

An outlet portion (111) may be provided at the bottom of the raw material supply part (110), and the outlet portion (111) is a passage through which the electrode raw material (50) is discharged from the raw material supply part (110). In addition, an inlet portion (131) into which the electrode raw material (50) is introduced may be provided at the top of the stirring part (130). At this time, the first pipe (175) may form the inlet portion (131) of the stirring part (130), and the second pipe (171) may form the outlet portion (111) of the raw material supply part (110).

In such a structure, the electrode raw material (50) in the raw material supply part (110) may be introduced into the stirring part (130) by sequentially passing through the second pipe (171) and the first pipe (175).

Also, the air injection part (140) and the vibration part (150) may each be provided in the first pipe (175). As one aspect, the air injection part (140) may be provided to spray air from the inside of the first pipe (175), and the vibration part (150) may be provided to apply vibration to the first pipe (175).

In addition, the control part (190) may be provided to operate the air injection part (140) and the vibration part (150) upon an input mode in which the electrode raw material (50) is introduced into the stirring part (130).

Furthermore, the control part (190) may operate the air injection part (140) to spray air at a first operating pressure lower than the internal pressure of the stirring part (130) upon the input mode. As one aspect, upon the input mode, the first operating pressure may be 0.1 MPa to 0.6 MPa. In addition, the first operating pressure may be 0.3 MPa to 0.4 MPa.

Upon the input mode of the electrode raw material (50), the air injection part (140) sprays air to the electrode raw material (50) flowing through the inlet portion (131), so that the electrode raw material (50) is dispersed in the form of powder, and performs the function of pushing the electrode raw material (50) in the electrode raw material input direction (F1).

Also, the electrode raw material transfer system (100) may comprise a vent pipe (210) connected to the stirring part (130). The control part (190) may be provided to open the vent pipe (210) to the outside (O) upon an input mode of the electrode raw material (50). Upon the input mode of the electrode raw material (50), as the pneumatic pressure sprayed from the air injection part (140) is applied to the inside of the stirring part (130), the pressure within the stirring part (130) may increase. In this instance, by opening the vent pipe (210) to the outside (O), it is possible to maintain the pressure within the stirring part (130) constant. An electronic valve (220) may be provided in the vent pipe (210). The electronic valve (220) is provided to open or close the vent pipe (210).

Meanwhile, a filter may be provided in the vent pipe (210). Therefore, the fluid discharged from the stirring part (130) along the vent pipe (210) may pass through the filter and then be discharged to the outside of the transfer system (100).

Referring to FIG. 4, the vibration part (150) may be provided outside the inlet portion (131). The vibration part (150) may be provided to apply vibration to the first pipe (175), and the vibration part (150) may be provided to apply vibration from the outside of the first pipe (175).

Also, the vibration part (150) may be arranged to be spaced apart from each air nozzle (141 to 144).

In addition, the vibration part (150) is provided to provide vibration (Fv) in a predetermined magnitude to the inlet portion (131). The intensity of vibration (Fv) generated in the vibration part (150) may be in a range of 1 kgf to 60 kgf. Furthermore, the intensity of vibration (Fv) generated in the vibration part (150) may be in the range of 20 kgf to 25 kgf. That is, the control part (190) may control the operation of the vibration part (150) so that vibration is applied at an intensity of 1 kgf to 60 kgf upon the input mode of the electrode raw material (50).

Furthermore, the vibration part (150) may comprise an air turbine vibrator. The air turbine vibrator is a device applying vibration to the inlet portion (131) using compressed air as a power source. As one aspect, the air turbine vibrator is known equipment, which may be a vibration device generating vibration force by rotating an internal rotary turbine gear.

The vibration part (150) provides vibration (Fv) to the inlet portion (131) upon the input mode of the electrode raw material (50). When the vibration part (150) operates, vibration occurs outside the first pipe (175). In this way, by applying vibration (Fv) to the inlet portion (131) upon the input mode of the electrode raw material (50), it is possible to prevent the electrode raw material (50) from being attached to the inner surface of the inlet portion (131) (or the inner surface of the first pipe).

As described above, the piping part (170) connects the outlet portion (111) of the raw material supply part (110) and the inlet portion (131) of the stirring part (130), and the piping part (170) performs the function of guiding the electrode raw material (50) from the raw material supply part (110) to the stirring part (130).

The second pipe (171) may constitute the outlet portion (111) of the raw material supply part (110), and the second pipe (171) may be made of a metal material having rigidity.

In addition, the first pipe (175) may be detachably coupled to the second pipe (171) by a clamp (177), and the first pipe (175) may be made of a metal material having rigidity.

The transfer system (100) for the electrode raw materials may be mounted on the second pipe (171), and may comprise an air knocker (180) provided to hit the second pipe (171) upon the input mode of the electrode raw material (50).

The air knocker (180) may be provided in the second pipe (171), and the air knocker (180) performs the function of preventing the electrode raw material (50) in the form of powder from being attached to the inner surface of the second pipe (171) by hitting the second pipe (171) upon the input mode of the electrode raw material (50).

The air knocker (180) is a known device, which may be, as one aspect, a vibrational impacting device dropping the electrode raw material (50) attached to the inner surface of the second pipe (171) in an indirect impact manner by counteraction between compressed air and magnetic force of a magnetic piston.

When the air knocker (180) operates, vibration occurs in the second pipe (171) by the force that the air knocker (180) strikes the second pipe (171). At this time, if the vibration generated from the air knocker (180) is transmitted to the stirring part (130), malfunction of the stirring part (130) may be caused.

To prevent this, the vibration reduction tube (173) may be provided to surround a partial region of the second pipe (171). In addition, the vibration reduction tube (173) may be formed of a silicone material. The vibration reduction tube (173) may prevent vibration from being transmitted from the second pipe (171) to the first pipe (175).

The control part (190) controls the operation of the raw material supply part (110), the stirring part (130), the air injection part (140), the vibration part (150), and the air knocker (180).

Upon the input mode of the electrode raw material (50), the control part (190) controls operation of the raw material supply part (110) so that the electrode raw material (50) is introduced into the inlet portion (131) through the outlet portion (111) of the raw material supply part (110). In addition, the control part (190) operates the stirring part (130) and opens the vent pipe (210) to the outside, upon the input mode of the electrode raw material (50).

Upon the input mode, the electrode raw material (50) discharged from the raw material supply part (110) passes through the inlet portion (131) while being transferred along the piping part (170), thereby being introduced into the stirring part (130).

Depending on the characteristics of the electrode raw material (50), a clogging phenomenon of the inlet portion (131) may occur, and to solve this, the control part (190) controls operation of the air injection part (140) and the vibration part (150) so that upon the input mode where the electrode raw material (50) is introduced into the stirring part (130), pneumatic pressure and vibration (Fv) are provided to the inlet portion (131, first pipe).

The control part (190) may be provided so that upon the input mode of the electrode raw material (50), the air injection part (140) and the vibration part (150) are operated continuously, and the air knocker (180) is operated at predetermined time intervals. As one aspect, upon the input mode of the electrode raw material (50), air may be continuously sprayed to the inside of the first pipe (175) by the air injection part (140), and vibration may be applied continuously to the first pipe (175) by the vibration part (150).

Also, the control part (190) may control the operation of the vibration part (150) so that vibration (Fv) with an intensity of 1 kgf to 60 kgf is provided to the inlet portion (131) upon the input mode of the electrode raw material (50).

Particularly, the control part (190) may control the operation of the air injection part (140) so that air is supplied at a first operating pressure lower than the internal pressure of the stirring part (130) upon the input mode of the electrode raw material (50).

In addition, when the pressure within the stirring part (130) decreases while air is supplied at a first operating pressure lower than the internal pressure of the stirring part (130) upon the input mode, the control part (190) may operate the air injection part (140) so that air is sprayed at a second operating pressure larger than the first operating pressure.

Specifically, in the process of maintaining the pressure of the stirring part (130) constant (the pressure at this time is called ‘set pressure’) upon the input mode of the electrode raw material (50), it may operate the air injection part (140) so that air is supplied at the first operating pressure, and when the pressure of the stirring part (130) becomes lower than the set pressure, it may operate the air injection part (140) so that air is sprayed at the second operating pressure greater than the first operating pressure.

When the electrode raw material (50) is attached inside the first pipe (175), the pneumatic pressure supplied through the air injection part (140) may not be properly transmitted to the stirring part (130), and in this case, the pressure within the stirring part (130) may be lowered. In this instance, the control part (190) operates the air injection part (140) so that air is sprayed at the second operating pressure greater than the first operating pressure, whereby it is possible to resolve the clogging phenomenon. In addition, when the pressure of the stirring part (130) becomes lower than the set pressure, the control part (190) may also increase the vibration intensity of the vibration part (150).

Meanwhile, if the pressure within the stirring part (130) exceeds the set pressure, the control part (190) may stop the input mode, and stop the operation of the air injection part (140) and the vibration part (150).

The preferred aspects of the present disclosure as described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### Industrial Applicability

According to the transfer system for electrode raw materials related to one aspect of the present disclosure, pneumatic pressure and vibration are applied to the inlet portion of the stirring part, whereby it is possible to prevent clogging of the inlet portion due to electrode raw materials during the mixing process.

1. An electrode raw material transfer system comprising:
a stirring part having an inlet portion into which electrode raw materials are introduced, and provided to perform a mixing process for the electrode raw materials;
a sensor part provided to measure a pressure within the stirring part;
an air injection part provided at the inlet portion of the stirring part and provided to spray air into the inlet portion;
a vibration part provided to apply vibration to the inlet portion; and
a control part provided to adjust an air injection pressure of the air injection part, based on the pressure within the stirring part.

2. The electrode raw material transfer system according to claim 1, wherein
the air injection part comprises: a plurality of air nozzles disposed within the inlet portion to spray air along the input direction of the electrode raw material;
a pneumatic supply part providing pneumatic pressure to each air nozzle; and
a regulator for controlling the pneumatic pressure supplied to each air nozzle.

3. The electrode raw material transfer system according to claim 2, wherein
the plurality of air nozzles is arranged apart from each other along the circumferential direction of the inlet portion.

4. The electrode raw material transfer system according to claim 1, wherein
the vibration part comprises an air turbine vibrator.

5. The electrode raw material transfer system according to claim 1, wherein
the control part is provided to operate the air injection part and the vibration part upon an input mode in which the electrode raw material is introduced into the stirring part.

6. The electrode raw material transfer system according to claim 5, wherein
the control part operates the air injection part so that the air is sprayed at a first operating pressure lower than the internal pressure of the stirring part upon the input mode.

7. The electrode raw material transfer system according to claim 6, wherein
upon the input mode, the first operating pressure is 0.1 MPa to 0.6 MPa.

8. The electrode raw material transfer system according to claim 5, wherein
the control part controls operation of the vibration part so that the vibration is applied at an intensity of 1 kgf to 60 kgf upon the input mode.

9. The electrode raw material transfer system according to claim 1, further comprising:
a raw material supply part having an outlet portion for supplying the electrode raw material to the stirring part; and
a piping part connecting the outlet portion and the inlet portion and guiding transfer of the electrode raw material from the raw material supply part to the stirring part.

10. The electrode raw material transfer system according to claim 9, wherein the piping part comprises:
a first pipe connected to the stirring part;
a second pipe connected to the raw material supply part; and
a vibration reduction tube provided in the second pipe.

11. The electrode raw material transfer system according to claim 10, further comprising
an air knocker mounted on the second pipe and provided to hit the second pipe upon an input mode of the electrode raw material.

12. The electrode raw material transfer system according to claim 11, wherein
the control part is provided to operate the air injection part and the vibration part continuously, and to operate the air knocker at predetermined time intervals, upon the input mode.

13. The electrode raw material transfer system according to claim 10, wherein
the vibration reduction tube is formed of a silicone material.

14. The electrode raw material transfer system according to claim 6, further comprising
a vent pipe connected to the stirring part, wherein
the control part is provided to open the vent pipe to the outside upon the input mode.

15. The electrode raw material transfer system according to claim 14, wherein
the control part operates the air injection part so that the air is sprayed at a second operating pressure greater than the first operating pressure when the pressure within the stirring part decreases upon the input mode.
